(19) United States
(12) Patent Application Publication
(10) Pub. No.: US 2010/0295874 A1
(43) Pub. Date: Nov. 25, 2010

(54) GAMMA VOLTAGE GENERATION DEVICE FOR A FLAT PANEL DISPLAY

(76) Inventors: Shang-I Liu, Kaohsiung City (TW); Wing-Kai Tang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/564,921

(22) Filed: Sep. 23, 2009

(30) Foreign Application Priority Data
May 20, 2009 (TW) 098116683

(51) Int. Cl. G06F 3/038; G09G 5/10

(52) U.S. Cl. 345/690; 345/211

(57) ABSTRACT

A gamma voltage generation device for a flat panel display includes a first voltage dividing circuit coupled between a high voltage and a low voltage, for generating a plurality of primary voltages, a plurality of primary selectors coupled to the first voltage dividing circuit, each of the plurality of primary selectors for selecting a primary voltage from the plurality of primary voltages according to an original digital value, a second voltage dividing circuit coupled to the plurality of primary voltages, for generating a plurality of secondary voltages, and a plurality of secondary selectors coupled to the second voltage dividing circuit, each of the plurality of secondary selectors for selecting a secondary voltage to be a reference grayscale voltage of a gamma curve from a predetermined number of secondary voltages of the plurality of secondary voltages according to a target digital value.

### BACKGROUND OF THE INVENTION

1. Field of the Invention

The present invention relates to a gamma voltage generation device for a flat panel display, and more particularly, to a gamma voltage generation device for adjusting a gamma curve to generate another gamma curve to be used.

2. Description of the Prior Art

Liquid crystal displays (LCD), characterized in low radiation, small size and low power consumption, have been widely used in various communication devices and consumer electronics. A backlight module is a key component in an LCD that consumes a large amount of power. In order to reduce power consumption of an LCD, a content adaptive backlight control (CABC) method is applied, which adaptively adjusts current consumption of the backlight module by different image content. On the other hand, the LCD requires enhancing the luminance of a displayed image when current consumption of the backlight module is reduced, to maintain the visual perception.

There are two conventional method of adjusting the luminance of an image, one is to adjust data slope and the other is to adjust a gamma curve. As to the method of adjusting data slope, original input pixel data Di_i is multiplied by a floating-point rate Ki corresponding to the i^{th} gray level for generating output pixel data Di_o, where Di_o=Ki×Di_i. Relationship between input pixel data and output pixel data may be piecewise-linear, nonlinear, or a specific transfer function, which leads to different effects on enhancement of luminance. In a source driver circuit of an LCD, there are digital-to-analog (D/A) converters, which convert the output pixel data Di_o into gamma voltages, also called grayscale voltages, for driving pixels according to a predetermined gamma curve. Since the D/A converters can only recognize integer data and cannot recognize floating-point data, the output pixel data Di_o are rounded up or down to integer data before the conversion through the D/A converters. As a result, the output pixel data may lose a part of gray levels; also, different output pixel data may be converted into the same grayscale voltage, causing loss in presentation of grayscale and image distortion.

The number of gray levels is related to color depth supported by an LCD. Take an LCD of 8-bits color depth as an example, there are 2⁸=256 gray levels each pixel can present, and each gray level corresponds to a voltage for driving a panel to display image with a corresponding luminance. A gamma curve illustrates a relationship between the luminance of an image and gray levels. Please refer to FIG. 1, which is a diagram illustrating a gamma curve of 256 gray levels according to the prior art, where the luminance of the image is indicated as grayscale voltage. In an LCD, a gamma voltage generation device is used for generating grayscale voltages corresponding to all gray levels, as shown in FIG. 1. Due to a concern of area cost, the gamma voltage generation device does not have D/A converters as much as gray levels. The gamma voltage generation device uses only several D/A converters to generate a number of reference grayscale voltages. The required grayscale voltages other than the reference grayscale voltages are generated by voltage dividing through a resistor series.

Please refer to FIG. 2, which is a schematic diagram of a gamma voltage generation device 20 for an LCD according to the prior art. The gamma voltage generation device 20 includes resistor series RA and RS, selectors SEL1-SEL6, and buffer amplifiers BF1-BF6, for generating a total of 64 grayscale voltages including 6 reference grayscale voltages. The resistor series RA includes 127 resistors coupled in series, two terminals of the resistor series RA coupled to a high voltage VH and a low voltage VL, respectively. A total of 128 different voltages, including the high voltage VH, the low voltage VL, and all voltages at nodes each between any two coupled resistors in the resistor series RA, are regarded as being generated by the resistor series RA . The selectors SEL1-SEL6 are D/A converters. Each selector is coupled to a corresponding register (which is not drawn in FIG. 2) in a timing controller of the LCD and is also coupled to the 128 different voltages generated by the resistor series RA. Each selector is utilized for selecting a voltage to be one of reference grayscale voltages from the 128 voltages according to a digital value outputted from the corresponding register. Each buffer amplifier is coupled to a corresponding selector, and is utilized for isolating the resistor series RA from the back-end resistor series RS, for preventing from voltages on the resistor series RA and RS being influenced by each other.

As shown in FIG. 2, the 6 reference grayscale voltages are indicated as AV0, AV8, AV20, AV43, AV55, and AV63, from the lowest to the highest, where AV0 indicates the voltage of gray level 0, corresponding to the minimum luminance, and AV63 indicates the voltage of gray level 63, corresponding to the maximum luminance. The number of resistors in the resistor series RS is related to the number of gray levels. As can be seen in FIG. 2, the resistor series RS includes 63 resistors coupled in series, two terminals of the resistor series RS coupled to the reference grayscale voltages AV0 and AV63, respectively. Each reference grayscale voltages, except AV0 and AV63, is coupled to a corresponding node between two coupled resistors in the resistor series RS. In addition, the grayscale voltages other than the aforementioned reference grayscale voltages are generated by voltage dividing through the resistor series RS.

Please refer to FIG. 3A, which is a diagram illustrating a gamma curve C₀ generated by the gamma voltage generation device 20 in FIG. 2. As shown in FIG. 3A, the 64 grayscale voltages are generated by interpolation through the resistor series RS based on the 6 reference grayscale voltages, forming the gamma curve C₀. The gamma voltage generation device 20 outputs the 64 grayscale voltages to D/A converters in the source driver circuit, so that pixel data can be displayed by proper gray levels. When the LCD applies the CABC method to reduce current consumption of the backlight module, the reference grayscale voltages should be adjusted correspondingly to enhance luminance of displayed images, to make visual perception similar to that before current consumption is reduced.

Please refer to FIG. 3B, which is a diagram illustrating relationship between the gamma curve C₀ and a gamma curve C_{T}. The gamma curve C_{T} is called a target gamma curve used when the CABC method is applied, marked as a dashed line. As can be seen in FIG. 3B, each reference grayscale voltage in the target gamma curve C_{T} is larger than the reference grayscale voltage of the same gray level in the gamma curve C₀. From the FIG. 3A and FIG. 3B, it is known that a size of register space storing digital values of reference grayscale voltages of the target gamma curve C_{T} is similar to a size of register space storing digital values of reference grayscale voltages of the original gamma curve C₀. Take the conventional gamma voltage generation device 20 as an example, the conventional gamma voltage generation device 20 requires a register of 6×7×2=84 bits to store all the digital values of reference grayscale voltages of a gamma curve, where 6 is the number of reference grayscale voltages, 7 is the number of bits for indicating 128 voltages that each selector can select, and 2 indicates that the polarity, positive and negative, is considered. If the LCD uses the gamma voltage generation device 20 to generate 8 target gamma curves, register space of 84×8=672 bits is required. And, taking size of register space in to account, a total of 672+84=756 bits register space is required, which is a huge burden for the LCD.

From the above, the method of adjusting data slope easily leads to image distortion, and the method of adjusting gamma curve does not result in image distortion, but requires a large register space to store digital values for enough gamma curves. There is still room for improvement as to the conventional method of adjusting the luminance of a displayed image.

### SUMMARY OF THE INVENTION

It is therefore a primary objective of the claimed invention to provide a gamma voltage generation device for a flat panel display.

The present invention discloses a gamma voltage generation device for a flat panel display. The gamma voltage generation device includes a first voltage dividing circuit, a plurality of primary selectors, a second voltage dividing circuit, and a plurality of secondary selectors. The first voltage dividing circuit is coupled between a high voltage and a low voltage, for generating a plurality of primary voltages. The plurality of primary selectors are coupled to the first voltage dividing circuit, each of the plurality of primary selectors for selecting a primary voltage from the plurality of primary voltages according to an original digital value. The second voltage dividing circuit is coupled to a plurality of primary voltages outputted by the plurality of primary selectors, and is utilized for performing voltage dividing for generating a plurality of secondary voltages. The plurality of secondary selectors are coupled to the second voltage dividing circuit, each of the plurality of secondary selectors for selecting a secondary voltage to be a reference grayscale voltage of a gamma curve from a predetermined number of secondary voltages of the plurality of secondary voltages according to a target digital value.

The present invention further discloses a gamma voltage generation device for a flat panel display for generating at least one gamma curve. The gamma voltage generation device includes a first voltage dividing circuit, a plurality of selectors, a first register unit, a second register unit, and an adding unit. The first voltage dividing circuit is coupled between a high voltage and a low voltage, for generating a plurality of voltages. The plurality of selectors are coupled to the first voltage dividing circuit, each of the plurality of selectors for selecting a voltage to be a reference grayscale voltage of the gamma curve from the plurality of voltages according to a target digital value. The first register unit is utilized for storing a plurality of original digital values. The second register unit is utilized for storing a plurality of digital values. The adding unit is coupled to the first register unit and the second register unit, and is utilized for adding each of the plurality of digital values to a corresponding one of the plurality of original digital values, for generating a plurality of target digital values corresponding to the plurality of selectors.

The present invention further discloses a gamma voltage generation device for a flat panel display for generating at least one gamma curve. The gamma voltage generation device includes a first voltage dividing circuit, a first selector, a second selector, and a second voltage dividing circuit. The first voltage dividing circuit is coupled between a first high voltage and a first low voltage for generating a plurality of voltages. The first selector is coupled to the first voltage dividing circuit, and is utilized for selecting a voltage to be a first reference grayscale voltage of the gamma curve from a first subset of the plurality of voltages according to a first target digital value. The second selector is coupled to the first voltage dividing circuit for selecting a voltage to be a second reference grayscale voltage of the gamma curve from a second subset, which is different from the first subset, of the plurality of voltages according to a second target digital value. The second voltage dividing circuit is coupled to the first reference grayscale voltage and the second reference grayscale voltage, and is utilized for performing voltage dividing between a second high voltage and a second low voltage according to the first reference grayscale voltage and the second reference grayscale voltage, for generating a plurality of grayscale voltages of the gamma curve.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a gamma curve of 256 gray levels according to the prior art.

FIG. 2 is a schematic diagram of a gamma voltage generation device for an LCD according to the prior art.

FIG. 3A is a diagram illustrating a gamma curve generated by the gamma voltage generation device in FIG. 2.

FIG. 3B is a diagram illustrating relationship between two gamma curves according to the prior art.

FIG. 4 is a schematic diagram of a gamma voltage generation device according to an embodiment of the present invention.

FIG. 5 is a table illustrating relationship between input pixel data and output pixel data.

FIG. 6 is a schematic diagram of a gamma voltage generation device according to an embodiment of the present invention.

FIG. 7 is a diagram illustrating a voltage difference between two gamma curves according to an embodiment of the present invention.

FIG. 8 is a schematic diagram of a gamma voltage generation device according to an embodiment of the present invention.

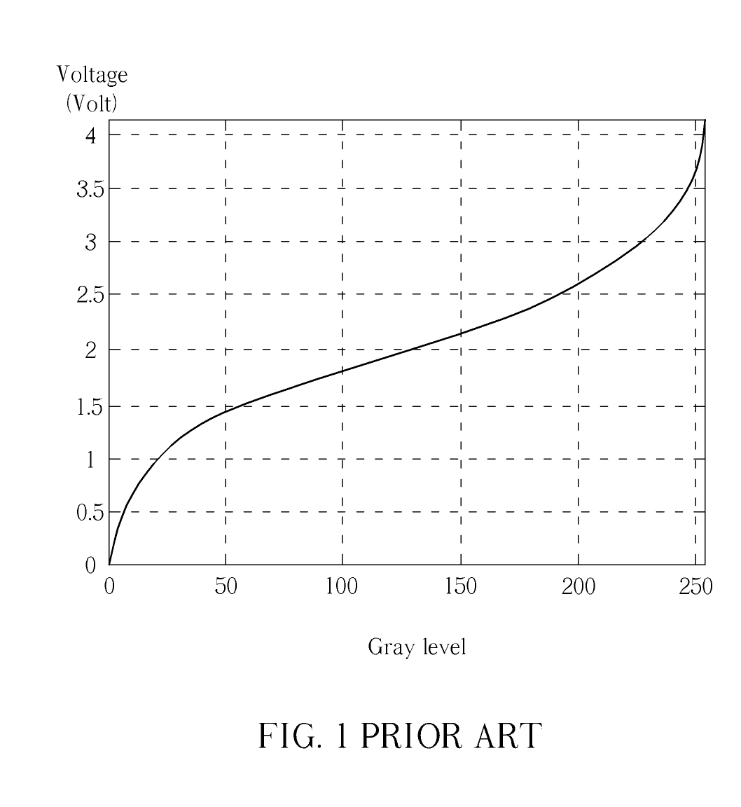

### DETAILED DESCRIPTION

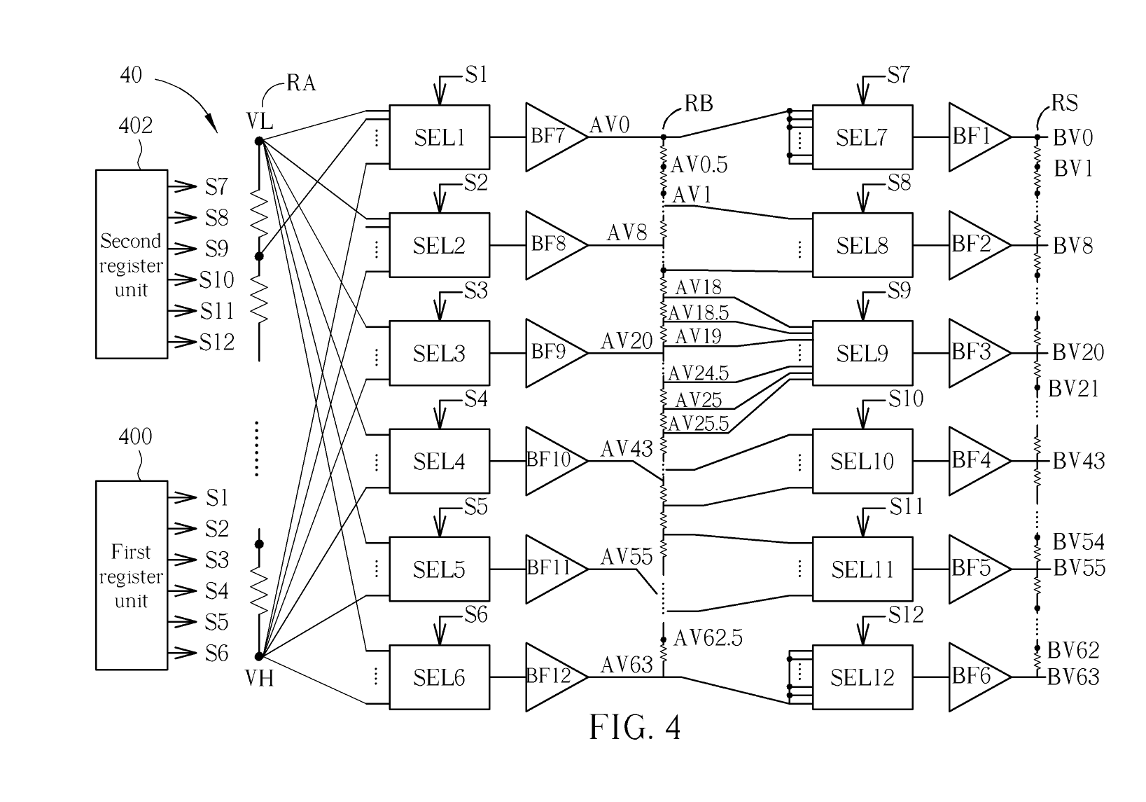

Please refer FIG. 4, which is a schematic diagram of a gamma voltage generation device 40 according to an embodiment of the present invention. The gamma voltage generation device 40 is utilized in an LCD for generates 64 grayscale voltages of a gamma curve, including 6 reference grayscale voltages. The gamma voltage generation device 40 not only generates an original gamma curve C₀, but also generates 8 target gamma curve C₁-C₈ that are used when the content adaptive backlight control (CABC) method is applied. Thus, the LCD can choose a proper target gamma curve corresponding to different backlight current consumption, to adjust luminance of displayed images.

The gamma voltage generation device 40 comprises a first register unit 400, a second register unit 402, resistor series RA, RB, and RS, selectors SEL1-SEL12, and buffer amplifiers BF1-BF12.

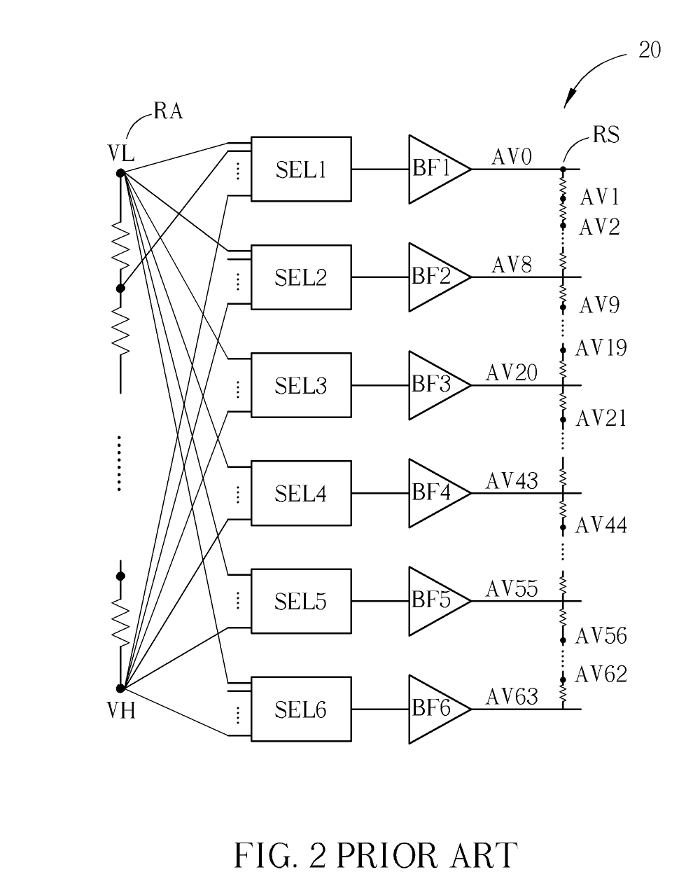

Compared with the gamma voltage generation device 20 in FIG. 2, the resistor series RB, the selectors SEL7-SEL12, and the buffer amplifiers BF7-BF12 are added between the selectors SEL1-SEL6 and the buffer amplifiers BF1-BF6. The 6 reference grayscale voltages are indicated as BV0, BV8, BV20, BV43, BV55, and BV63, corresponding to the gray level 0, 8, 20, 43, 55 and 63, respectively. Note that, the number of selectors, the number of buffer amplifiers, and which gray level each reference grayscale voltage corresponds to shown in FIG. 4 is one embodiment of the present invention, and can be changed according to requirements.

The gamma voltage generation device 40 is regard as a two-stage gamma voltage generation device, where the resistor series RA, the selectors SEL1-SEL6 and the buffer amplifiers BF7-BF12 are regarded as a primary stage, and the resistor series RB, the selectors SEL7-SEL12 and the buffer amplifiers BF1-BF6 are regarded as a secondary stage. The resistor series RS performs voltage dividing to generate all the grayscale voltages (except the reference grayscale voltages) that are outputted to a source driver circuit of the LCD. On the other hand, the 6 reference grayscale voltages are generated by an earlier first-stage selecting through the selectors SEL1-SEL6 and a later second-stage selecting through the selectors SEL7-SEL12. The resistor series RA, RB, and RS are regarded as voltage dividing circuits in the gamma voltage generation device 40 and following embodiments.

The first register unit 400 is located in a timing controller in the LCD, and is utilized for storing digital values S1-S6 and outputting each of the digital value S1-S6 to a corresponding one of the selectors SEL1-SEL6, e.g. the digital value S3 is outputted to the selector SEL3. The digital values S1-S6 correspond to 6 reference grayscale voltages of the original gamma curve C₀. The resistor series RA comprises 127 resistors coupled in series, two terminals of the resistor series RA coupled to a high voltage VH and a low voltage VL, respectively. A total of 128 different voltages, including the high voltage VH, the low voltage VL, and all the voltages at nodes each between any two coupled resistors in the resistor series RA, are regarded as candidate voltages for the first-stage selecting through SEL1-SEL6 and being generated by the resistor series RA.

Each of the selectors SEL1-SEL6 is coupled to the first register unit 400 and the 128 different candidate voltages, and is utilized for selecting a candidate voltage from the 128 candidate voltages according to a corresponding one of the digital values S1-S6. As a result, the selectors SEL1-SEL6 output a total of 6 voltages, indicated as AV0, AV8, AV20, AV43, AV55, and AV63, which are grayscale voltages in the original gamma curve Cₒ corresponding to gray level 0, 8, 20, 43, 55, and 63, respectively. Each of the buffer amplifiers BF7-BF12 is coupled to a corresponding one of the selectors SEL1-SEL6, and is utilized for buffering voltages that are outputted the resistor series RB. Note that, the buffer amplifiers BF7-BF12 are utilized for isolating the resistor series RA from the influence caused by voltages on the resistor series RB. In another embodiment of the present invention, when resistances of resistors in the resistor series RA and RB are designed to prevent from the voltage influence, the buffer amplifiers BF7-BF12 can be omitted. In other words, each of the digital values S1-S6 is utilized to control a corresponding selector to select a voltage from the 128 candidate voltages, and thereby each of the digital values S1-S6 is indicated by 7 bits. Therefore, the first register unit 400 has register space no less than 6×7×2=84 bits to store digital values of the 6 reference grayscale voltages of the original gamma curve C₀. Some variations for the primary stage of the gamma voltage generation device 40, for example, each of the selectors SEL1-SEL6 is coupled to a number of candidate voltages instead of being coupled to all the candidate voltages, which do not limit to the present invention.

The second register unit 402 is located in the timing controller, and is utilized for storing digital values S7-S12 and outputting each of the digital values S7-S12 to a corresponding one of the selectors

SEL7-SEL12. The digital values S7-S12 correspond to 6 reference grayscale voltages of one of the target gamma curves C₁-C₈, indicated as C_{T}. In fact, the second register unit 402 also stores digital values of reference grayscale voltages of other 7 target gamma curves, which are omitted in FIG. 4 for a simple explanation. The resistor series RB comprises 127 resistors coupled in series, two terminals of the resistor series RA coupled to the lowest voltage AV0 and the highest voltage AV63 which are selected by the selectors SEL1 and SEL6. Each of the voltages AV8, AV20, AV43, and AV55 is coupled to a corresponding node between two coupled resistors in the resistor series RB. The resistor series RB performs voltage dividing between the voltages AV0 and AV63, and thus generates voltages AV0.5, AV1 . . . AV62, and AV62.5, where voltage differences between any two neighbor voltages are equal. The more resistors the resistor series RB includes, the more floating-point grayscale voltages can be selected, and therefore the higher resolution of grayscale the LCD can achieve.

Each of the selectors SEL7-SEL12 is coupled to the second register unit 402 and a predetermined number of voltages indicated as AVn-AVm from the voltages AV0, AV0.5 . . . AV62.5, and AV63, and is utilized for selecting one voltage from all the voltages AVn-AVm according to a corresponding one of the digital values S7-S12. On the other hand, each of the digital values S7-S12 should be a number of bits that are enough to indicate the number of voltages AVn-AVm. For example, if the selector SEL9 is coupled to 8 voltages, the digital value S9 is indicated by 3 bits at least. The selectors SEL7-SEL12 outputs a total of 6 reference grayscale voltages BV0, BV8, BV20, BV43, BV55, and BV63, corresponding to the gray level 0, 8, 20, 43, 55, and 63, respectively, of the target gamma curve C_{T}. Each of the buffer amplifiers BF1-BF6 is coupled to a corresponding one of the selectors SEL7-SEL12, and is utilized for buffering voltages outputted from the selector SEL7-SEL12 and then outputting to the resistor series RS. Similar to the buffer amplifiers BF7-BF12, the buffer amplifiers BF1-BF6 are also utilized for isolating the front-end circuitry and the back-end circuitry. Note that, since the resistor series RS is next to the source driver circuit, the resistances of resistors in the resistor series RS cannot be designed at random, and the buffer amplifiers BF1-BF6 usually cannot be omitted.

The resistor series RS is utilized for generating 64 grayscale voltages that is outputted to the source driver circuit. The resistor series RS comprises 63 resistors coupled in series, two terminals of the resistor series RS coupled to the lowest reference grayscale voltage BV0 and the highest reference grayscale voltage BV63, respectively. Each of the reference grayscale voltages BV8, BV20, BV43, and BV55 is coupled to a corresponding node between two coupled resistors in the resistor series RS. Other grayscale voltages except the reference grayscale voltages are generated by interpolation based on the reference grayscale voltages and by voltage dividing through the resistor series RS.

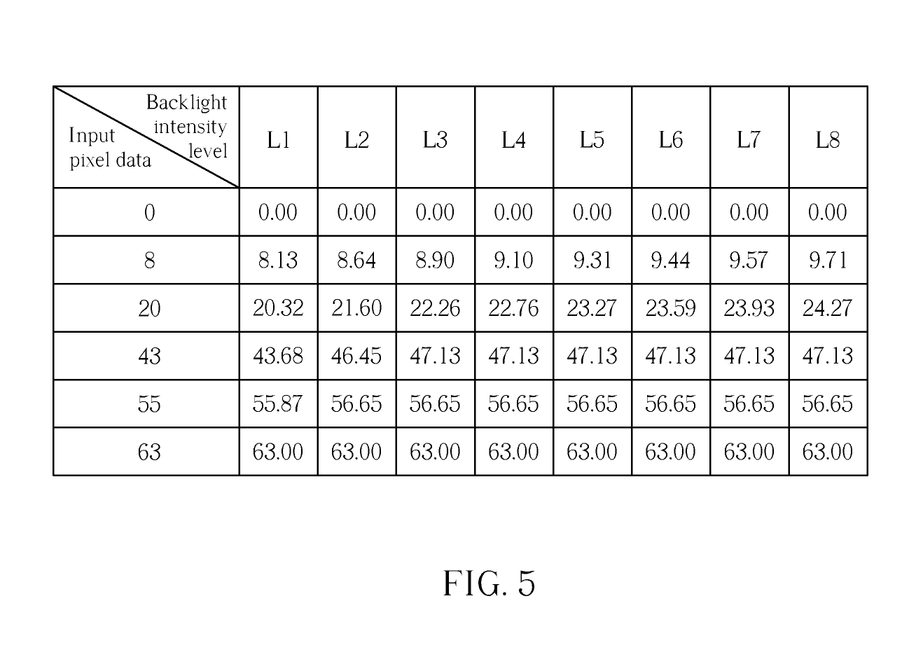

From the above, two-stage reference grayscale voltage selecting is the concept of the present invention. The reason why the present invention uses this concept is described as follows. Please refer FIG. 5, which is a table illustrating relationship between input pixel data and output pixel data. The table in FIG. 5 is used for the conventional method of adjusting data slope. As in FIG. 5, input pixel data of gray levels 0, 8, 20, 43, 55, and 63 are listed, and corresponding output pixel data which is the input pixel data multiplied by a floating-point rate are listed by different 8 backlight intensity levels L1-L8. The output pixel data indicates real gray level to be displayed. Take the input pixel data of the gray level 20 as an example, the output pixel data listed by the backlight intensity levels L1-L8 are floating-point gray levels 20.32, 21.60, 22.26, 22.76, 23.27, 23.59, 23.93, and 24.27. The out pixel data with the largest difference to the input pixel data is used for the backlight intensity level L8, where the difference is 4.27. As can be seen in FIG. 5, the output pixel data for different backlight intensity levels is still within a range and is close to the input pixel data. That is, when a voltage is selected to be a grayscale voltage of the original gamma curve C₀, grayscale voltages corresponding to the same gray level of different target gamma curves will be within a range and close to the selected voltage.

In the gamma voltage generation device 40, each of the selectors SEL1-SEL6 selects a voltage to be a reference grayscale voltage AVi of the original gamma curve C₀ according to a 7-bit digital value. After all the reference grayscale voltages of the original gamma curve C₀ are decided, each of the selectors SEL7-SEL12 only needs to select a reference grayscale voltage of the target gamma curve C_{T} from a range of voltages AVn-AVm close to the voltage AVi, which is a part of all the floating-point grayscale voltages generated by the resistor series RB, instead of selecting from all the floating-point grayscale voltages AV0, AV0.5, . . . , AV62.5, and AV63. That is, the number of bits of the digital values used for controlling the selectors SEL7-SEL12 is reduced to be 3 or 4 bits. On the other hand, when the voltage range that the selectors SEL7-SEL12 can select from is reduced, register space of the second register unit 402 for storing the digital values S7-S12 is reduced correspondingly, and thus cost of the LCD is reduced.

As can be seen in FIG. 4, the selector SEL9 is detailed illustrated for an example. The selector SEL9 is coupled to 16 voltages as AV18, AV18.5, . . . , AV25, and AV25.5. Assume that the digital values S7-S12 stored in the second register unit 402 are used for controlling the selectors SEL7-SEL12 to select reference grayscale voltages of the target gamma curve C₈, which is used when the backlight intensity is the smallest. Based on the above assumption, the selector SEL9 may select the voltage AV24.5 to be a reference grayscale voltage BV20 of the target gamma curve C₈ according to the digital value S9. As can be seen, the number of voltages coupled to each of the selectors SEL7-SEL12 indicates the range that a reference grayscale voltage can be adjusted. In another embodiment, the number of voltages coupled to one selector may be different from the number of voltages coupled to another selector. In addition, as to the gamma voltage generation device 40, the voltages coupled to each of the selectors SEL7-SEL12 includes the reference grayscale voltage of the original gamma curve C₀, e.g. the voltages from AV18 to AV25.5 includes the grayscale voltages AV20, which is the voltage of gray level 20, of the original gamma curve C₀. Therefore, the gamma voltage generation device 40 not only outputs 8 target gamma curves, but also outputs the original gamma curve.

Note that, in the gamma voltage generation device 40, the highest grayscale voltage and the lowest grayscale voltage of each target gamma curve are assumed to be identical to that of the original gamma curve. As in FIG. 4, all the input terminals of the selector SEL7 are coupled to the voltage AV0, and also, all the input terminals of the selector SEL12 are coupled to the voltage AV63. In this situation, the selectors SEL7 and SEL12 can be omitted, and the voltages AV0 and AV63 are directly coupled to the buffer amplifiers BF7 and BF12, respectively. In another embodiment, the selector SEL7 or SEL12 is coupled to a predetermined range of voltages and selects a reference grayscale voltage from the predetermined range of voltages.

As shown in FIG. 4, the digital value S9 should be a 4-bits digital value because the selector SEL9 is coupled to 16 voltages. Assume that the number of voltages coupled to each of the selectors SEL7-SEL12 is 16, the second register unit 402 requires register space of 6×4×2=48 bits for storing digital values of reference grayscale voltages of a target gamma curve, and therefore requires register space of 48×8=384 bits for storing digital values for a total of 8 target gamma curves. Register space of the first register unit 400 and the second register unit 402 are accumulated to be 84+384=468 bits. Compared with the gamma voltage generation device 20 in FIG. 2 that requires register space of 672 bits to store 8 gamma curves, the embodiment of the present invention reduces register space considerably. The flexibility of determining the voltage range that each of the selectors SEL7-SEL12 can select from is a great help for a designer to find out an expected target gamma curve.

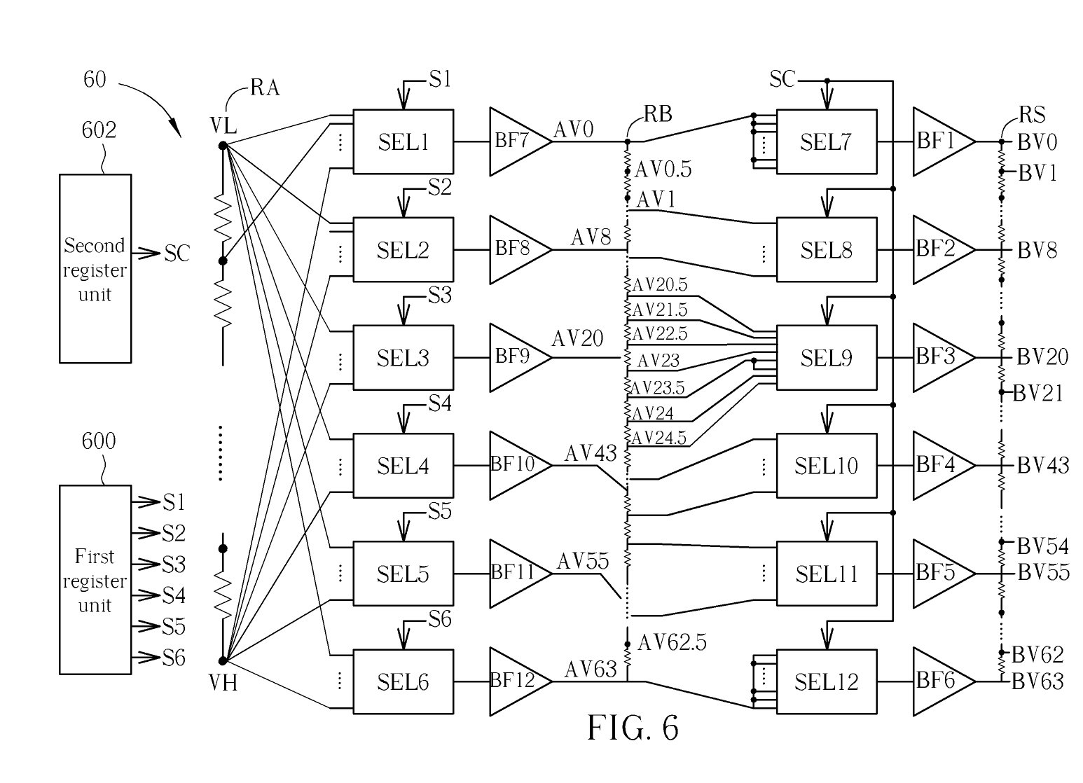

The gamma voltage generation device 40 is one of embodiments of the present invention, and those skilled in the art can make alterations and modifications accordingly. Please refer to FIG. 6, which is a schematic diagram of a gamma voltage generation device 60 according to an embodiment of the present invention. The gamma voltage generation device 60 comprises a first register unit 600, a second register unit 602, resistor series RA, RB, and RS, selectors SEL1-SEL12, and buffer amplifiers BF1-BF12. The gamma voltage generation device 60 is similar to the gamma voltage generation device 40, which is not described in detail herein. The only difference is that the second register unit 602, the selectors SEL7-SEL12 and the resistor series RB in FIG. 6 are different from units and circuitry of the same functions in the gamma voltage generation device 40.

In the gamma voltage generation device 60, each of the selectors SEL7-SEL12 can only select a voltage from 8 reference grayscale voltages which are predetermined corresponding to the target gamma curves C₁-C₈. The second register unit 602 is utilized for storing a 3-bits digital value SC, and outputting the digital value SC to each of the selectors SEL7-SEL12. The digital value SC indicates which the target gamma curve is. The selectors SEL7-SEL12 are coupled to voltages which are exactly the reference grayscale voltages of the target gamma curves C₁-C₈. Since grayscale voltages of the same gray level may be identical in different gamma curves, input terminals of each selector may be coupled to the same voltage. As can be seen in FIG. 6, 8 input terminals of the selector SEL9 are coupled to voltages, AV21.5, AV22.5, AV23, AV23.5, AV23.5, AV 24, and AV 24.5, which are the grayscale voltage of gray level 20 of the target gamma curves C₁-C₈; the grayscale voltage of gray level 20 in the target gamma curves C₅ and C₆ are identical. The selector SEL9 selects one of grayscale voltages to be the grayscale voltage of gray level 20, indicated as BV20, of the selected target gamma curve according to the digital value SC. Compared to the gamma voltage generation device 40, register space of the second register unit 602 for storing the digital value SC is much less than the required register space of the second register unit 402. From the above, each of the selectors SEL7-SEL12 in the gamma voltage generation device 40 or 60 only requires selecting a reference grayscale voltage from a predetermined voltage range or a predetermined voltage subset instead of selecting from all the voltages generated by the resistor series RB, and thus the register space is reduced much than the conventional gamma voltage generation device in FIG. 2.

Furthermore, in another embodiment, the digital value SC in the gamma voltage generation device 60 can be a 4-bits digital value in order to output the original gamma curve Cₒ additionally. At the same time, each of the selectors SEL7-SEL12 should have 8+1=9 input terminals, and the additional input terminal is coupled to a reference grayscale voltage of the original gamma curve C₀, e.g. the voltage AV0, AV8, AV20, AV43, AV55, or AV63 generated by the resistor series RB. Or, each of the selectors SEL7-SEL12 has 8 input terminals and six 2-to-1 selectors are added to be coupled to the output terminals of the selectors SEL7-SEL12, respectively, and the voltages AV0, AV8, AV20, AV43, AV55, and AV63 are respectively coupled to these 2-to-1 selectors. Therefore, the 2-to-1 selectors output the reference grayscale voltages of the original gamma curve, or one of the target gamma curves.

Compared with the conventional gamma voltage generation device 20 in prior art, the resistor series RB, the selectors SEL7-SEL12 and the buffer amplifiers BF7-BF12 are added in the gamma voltage generation devices 40 and 60, so that the secondary stage of selecting is performed. Note that, the number of resistors in the resistor series RB is enough for generating voltages selected by the selector SEL7-SEL12, which fulfills the grayscale resolution higher than that the resistor series RA can provides. In another embodiment, the gamma voltage generation device comprises circuitry similar to the prior art, for selecting the reference grayscale voltages by only one stage, and the number of resistors in the resistor series RA is as much as that in the resistor series RB in FIG. 4. In this situation, each selector selects the reference grayscale voltage from a predetermined voltage range instead of all the voltages generated by resistor series RA, and thus a gamma curve is generated.

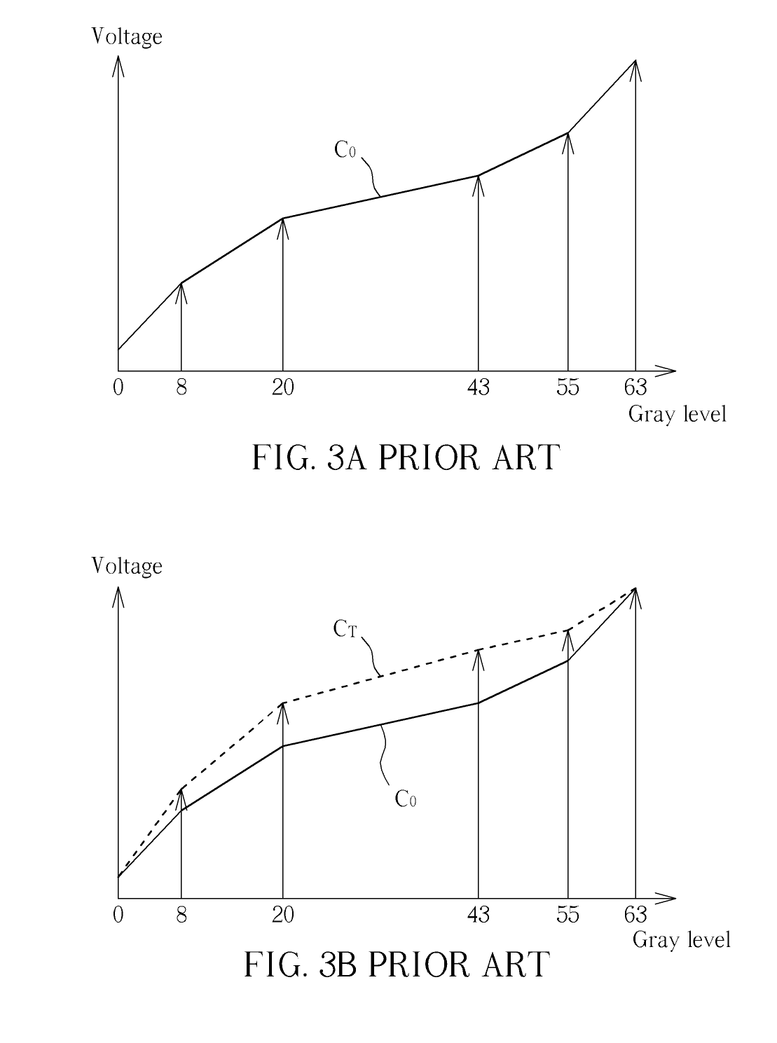

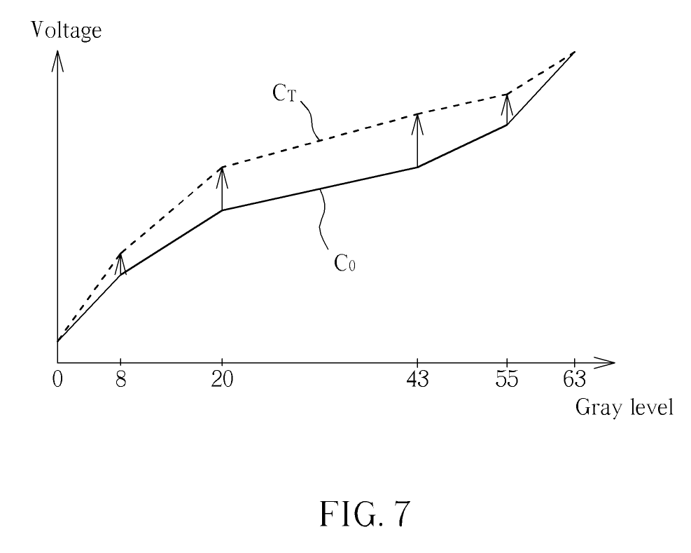

Please refer to FIG. 7, which is a diagram illustrating the gamma curve Cₒ and a target gamma curve C_{T} according to an embodiment of the present invention, similar to FIG. 3B. As can be seen in FIG. 7, if a voltage differences between a reference grayscale voltage of the target gamma curve C_{T} and a reference grayscale voltage of the original gamma curve C₀ is presented by a digital value, the number of bits of this digital value is far less than the number of bits for presenting an entire reference grayscale voltage of the target gamma curve C_{T}. For example, if each reference grayscale voltage of the original gamma curve C₀ is indicated as a 7-bits digital value, the voltage difference between the target gamma curve C_{T} and the original gamma curve C₀ can be indicated as a 3-bits digital value.

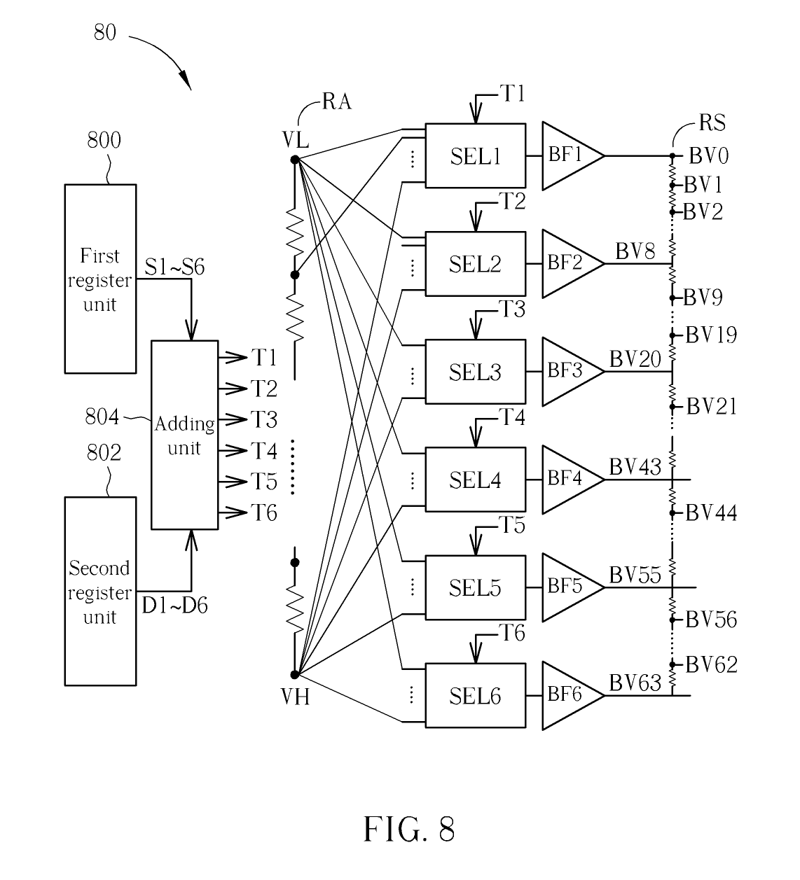

Based on the concept shown in FIG. 7, the present invention further provides another embodiment, which reduces register space by storing digital values of voltage differences. Please refer to FIG. 8, which is a schematic diagram of a gamma voltage generation device 80 according to an embodiment of the present invention. The gamma voltage generation device 80 generates 64 grayscale voltages, including 6 reference grayscale voltages, for a gamma curve, and can generate multiple target gamma curves used when the CABC method is applied. The gamma voltage generation device 80 comprises a first register unit 800, a second register unit 802, an adding unit 804, resistor series RA and RS, selectors SEL1-SEL6, and buffer amplifiers BF1-BF6.

The first register unit 800 is utilized for storing digital values S1-S6 corresponding to 6 reference grayscale voltages of an original gamma curve C₀, and outputting the digital value S1-S6 to the adding unit 804. The second register 702 is utilized for storing digital values D1-D6 corresponding to voltage differences between reference grayscale voltages of an original gamma curve C₀ and reference grayscale voltages of a target gamma curve C_{T}, and outputting the digital values D1-D6 to the adding unit 804. Note that, the digital values D1-D6 in the FIG. 8 is indicated for one target gamma curve for a simple explanation; in fact, the second register unit 802 stores digital values for multiple target gamma curves, not only for one target gamma curve. The adding unit 804 is coupled to the first register unit 800, the second register unit 802, and the selectors SEL1-SEL6, and is utilized for adding each of the digital values D1-D6 to a corresponding one of the digital values S1-S6, for generating digital values T1-T6 that are outputted to the selectors SEL1-SEL6, respectively. The digital values T1-T6 indicate reference grayscale voltages of the target gamma curve C_{T}.

As in FIG. 8, the resistor series RA comprises 127 resistors coupled in series, two terminals of the resistor series RA coupled to a high voltage VH and a low voltage VL. The resistor series RA generates 128 voltages of different levels as candidate voltages for the primary stage of selecting. Each of the selectors SEL1-SEL6 is coupled to the adding unit 804 and the 128 candidate voltages, and is utilized for selecting a candidate voltage to be a reference grayscale voltage according to a corresponding one of the digital values T1-T6 generated by the adding unit 804. The selectors SEL1-SEL6 outputs voltages BV0, BV8, BV20, BV43, BV55, and BV63 to be reference grayscale voltages of the target gamma curve C_{T}, corresponding to gray level 0, 8, 20, 43, 55, and 63. Each of the buffer amplifiers BF1-BF6 is coupled to a corresponding one of the selectors SEL1-SEL6, and is utilized for buffering the reference grayscale voltages that are outputted to the resistor series RS. The resistor series RS is utilized for generating a total of 64 grayscale voltages, outputted to the source driver circuit of the LCD. The resistor series RA and RS, the selectors SEL1-SEL6, and the buffer amplifiers BF1-BF6 are illustrated in detail in the previous embodiments and are not repeated herein. Since the digital values stored in the second register unit 802 indicate voltage differences instead of entire reference grayscale voltages, register space in the gamma voltage generation device 80 is efficiently reduced.

In conclusion, the present invention provides two different gamma voltage generation devices. One is a gamma voltage generation device including two stages, a primary stage and a secondary stage, for selecting reference grayscale voltages, and thereby the register space is efficiently reduced by the secondary stage of selecting, and the required target gamma curve is easier to be adjusted. The other is a gamma voltage generation device that includes a register unit storing digital values of voltage differences between a target gamma curve and an original gamma curve, so that register space is also reduced. Therefore, cost of an LCD is reduced.

Those skilled in the art will readily observe that numerous modifications and alterations of the device and method may be made while retaining the teachings of the invention.

What is claimed is:

1. A gamma voltage generation device for a flat panel display comprising:
a first voltage dividing circuit coupled between a high voltage
and a low voltage, for generating a plurality of primary voltages;
a plurality of primary selectors coupled to the first voltage
dividing circuit, each of the plurality of primary selectors for selecting a primary voltage from the plurality of primary voltages according to an original digital value;
a second voltage dividing circuit coupled to a plurality of primary
voltages outputted by the plurality of primary selectors, for performing voltage dividing for generating a plurality of secondary voltages; and
a plurality of secondary selectors coupled to the second voltage
dividing circuit, each of the plurality of secondary selectors for selecting a secondary voltage to be a reference grayscale voltage of a gamma curve from a predetermined number of secondary voltages of the plurality of secondary voltages according to a target digital value.

2. The gamma voltage generation device of claim 1 further comprising:
a third voltage dividing circuit coupled between the highest
voltage and the lowest voltage of a plurality of reference grayscale voltages outputted by the plurality of secondary selectors, for performing voltage dividing according to the plurality of the reference grayscale voltages, for generating a plurality of the grayscale voltages of the gamma curve.

3. The gamma voltage generation device of claim 1 further comprising:
a register unit coupled to the plurality of primary selectors,
for storing a plurality of original digital values and outputting each of the plurality of original digital values to a corresponding one of the plurality of primary selectors.

4. The gamma voltage generation device of claim 1 further comprising:
a register unit coupled to the plurality of secondary selectors,
for storing a plurality of target digital values and outputting each of the plurality of target digital values to a corresponding one of the plurality of secondary selectors.

5. The gamma voltage generation device of claim 1 further comprising:
a register unit coupled to the plurality of secondary selectors,
for storing a first target digital value corresponding to the gamma curve and outputting the first target digital value to each of the plurality of secondary selectors.

6. The gamma voltage generation device of claim 1 further comprising:
a plurality of secondary buffer amplifiers, each of the plurality
of secondary buffer amplifiers coupled to a corresponding one of the plurality of secondary selectors, for buffering a reference grayscale voltage outputted by the corresponding secondary selector.

7. The gamma voltage generation device of claim 6, wherein one of the plurality of secondary buffer amplifiers is coupled to one of the plurality of secondary voltages.

8. The gamma voltage generation device of claim 1, wherein two terminals of the second voltage dividing circuit are respectively coupled to the highest voltage and the lowest voltage of the plurality of primary voltages.

9. The gamma voltage generation device of claim 1 further comprising:
a plurality of primary buffer amplifiers, each of the plurality
of primary buffer amplifiers coupled between a corresponding one of the plurality of primary electors and a corresponding voltage generated by the second voltage dividing circuit, for buffering a voltage outputted by the corresponding primary selector.

10. The gamma voltage generation device of claim 1, wherein the number of bits of the target digital value corresponds to the predetermined number.

11. A gamma voltage generation device for a flat panel display for generating at least one gamma curve, the gamma voltage generation device comprising:
a first voltage dividing circuit coupled between a high voltage
and a low voltage, for generating a plurality of voltages;
a plurality of selectors coupled to the first voltage dividing
circuit, each of the plurality of selectors for selecting a voltage to be a reference grayscale voltage of the gamma curve from the plurality of voltages according to a target digital value;
a first register unit for storing a plurality of original digital values;
a second register unit for storing a plurality of digital values; and
an adding unit coupled to the first register unit and the second
register unit, for adding each of the plurality of digital values to a corresponding one of the plurality of original digital values, for generating a plurality of target digital values corresponding to the plurality of selectors.

12. The gamma voltage generation device of claim 11 further comprising:
a plurality of buffer amplifiers, each of the plurality of buffer
amplifiers is coupled to a corresponding one of the plurality of selectors, for buffering a reference grayscale voltage outputted by the corresponding selector.

13. The gamma voltage generation device of claim 11 further comprising:
a second voltage dividing circuit coupled between the highest
voltage and the lowest voltage of a plurality of reference grayscale voltages outputted by the plurality of selectors, for generating a plurality of grayscale voltages of the gamma curve according to the plurality of reference grayscale voltage.

14. A gamma voltage generation device for a flat panel display for generating at least one gamma curve, the gamma voltage generation device comprising:
a first voltage dividing circuit coupled between a first high
voltage and a first low voltage, for generating a plurality of voltages;
a first selector coupled to the first voltage dividing circuit,
for selecting a voltage to be a first reference grayscale voltage of the gamma curve from a first subset of the plurality of voltages according to a first target digital value;
a second selector coupled to the first voltage dividing circuit,
for selecting a voltage to be a second reference grayscale voltage of the gamma curve from a second subset, which is different from the first subset, of the plurality of voltages according to a second target digital value; and
a second voltage dividing circuit coupled to the first reference
grayscale voltage and the second reference grayscale voltage, for performing voltage dividing between a second high voltage and a second low voltage according to the first reference grayscale voltage and the second reference grayscale voltage, for generating a plurality of grayscale voltages of the gamma curve.

15. The gamma voltage generation device of claim 14, wherein the number of bits of the first target digital value corresponds to the number of voltages in the first subset.

16. The gamma voltage generation device of claim 14, wherein the number of bits of the second target digital value corresponds to the number of voltages in the second subset.
